(19) United States
(12) Patent Application Publication
(10) Pub. No.: US 2012/0306744 A1
(43) Pub. Date: Dec. 6, 2012

(54) ELECTRONIC DEVICE WITH ILLUMINATING TOUCHPAD

(76) Inventors: Dustin L. Hoffman, Cypress, TX (US); Michael Delpier, Houston, TX (US); Peter M. On, Houston, TX (US)

(21) Appl. No.: 13/151,056

(22) Filed: Jun. 1, 2011

(51) Int. Cl. G06F 3/033; G06F 3/041

(52) U.S. Cl. 345/157; 345/173

(57) ABSTRACT

An electronic device having a touchpad that illuminates.

### BACKGROUND

Some computing devices use a touchpad as a pointing device. The touchpad is located on the computing device and includes a specialized surface that translates movement of a user's fingers to a position of a cursor on a screen of the computing device. Touchpads are found on many laptop computers and other portable computing devices and offer a popular substitute for a separate mouse, computer pen, or other point device.

### BRIEF DESCRIPTION OF THE DRAWINGS

FIG. 1A is an electronic device in a power-off state in accordance with an example implementation.

FIG. 1B is the electronic device in a power-on state with a touchpad illuminated in accordance with an example implementation.

FIG. 1C is the electronic device in the power-on state with the touchpad not being illuminated in accordance with an example implementation.

FIG. 1D is the electronic device in the power-on state with the touchpad being activated to re-illuminate in accordance with an example implementation.

FIG. 1E is the electronic device in the power-on state with the touchpad illuminated after being activated in accordance with an example implementation.

FIG. 2 is a method for illuminating a touchpad on an electronic device in accordance with an example implementation.

FIG. 3A is another example of an electronic device in a power-on state with a touchpad illuminated in accordance with an example implementation.

FIG. 3B is a cross-section of the base showing the touchpad and light source in accordance with an example implementation.

FIG. 4 is a block diagram of an electronic device with a touchpad that illuminates in accordance with an example implementation.

### DETAILED DESCRIPTION

Example embodiments are apparatus and methods that illuminate a touchpad of an electronic device. The electronic device includes a display and a touchpad that controls a cursor on the display. The touchpad seamlessly integrates with a surface of a body of the electronic device that surrounds the touchpad. As such, no part lines exist between touchpad and the area surrounding the touchpad. A light source illuminates the touchpad so a user can identify the boundaries of the touchpad and distinguish it from other areas of the electronic device.

Textures can be used to distinguish the area surrounding the touchpad with the area of the touchpad itself. If the touchpad has a texture that is different from the texture of the surrounding area, then this difference can be perceived by a user in order to identify the location of the touchpad on the electronic device. Textures, however, may be undesirable since they can limit potential designs of the palmrest area. Textures can also make molds harder to maintain, which increases manufacturing costs for the electronic device.

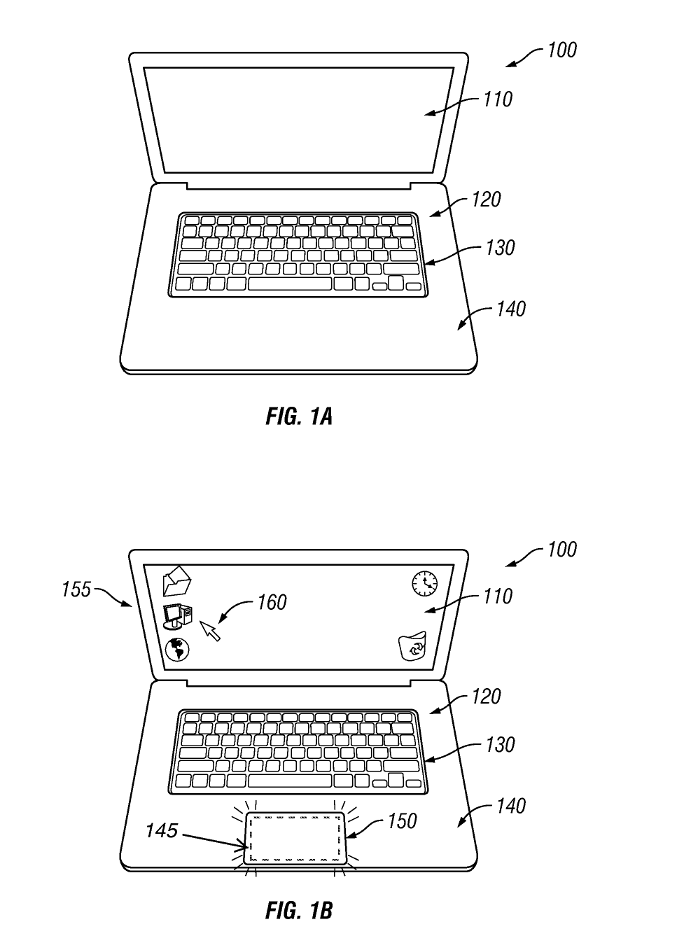

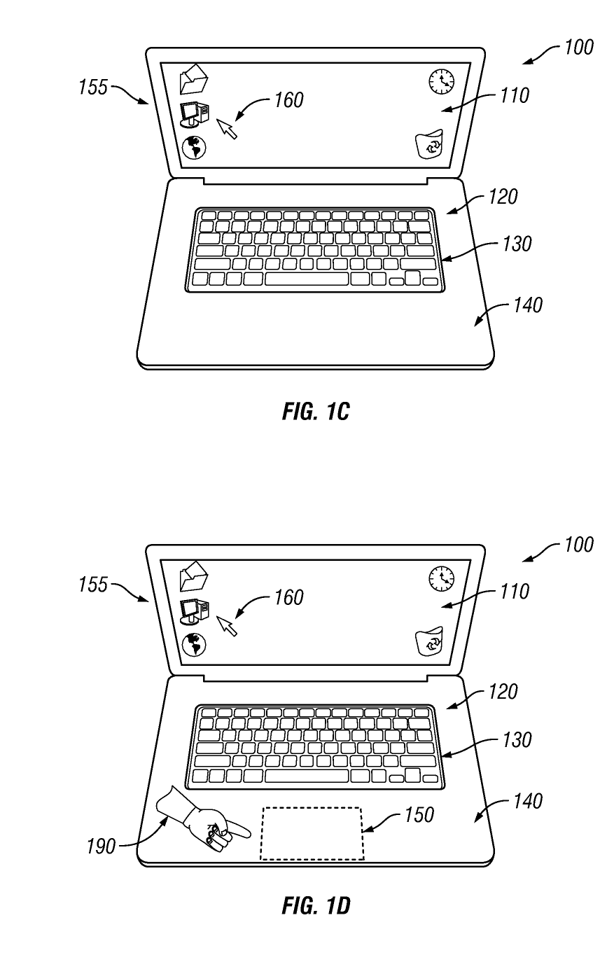

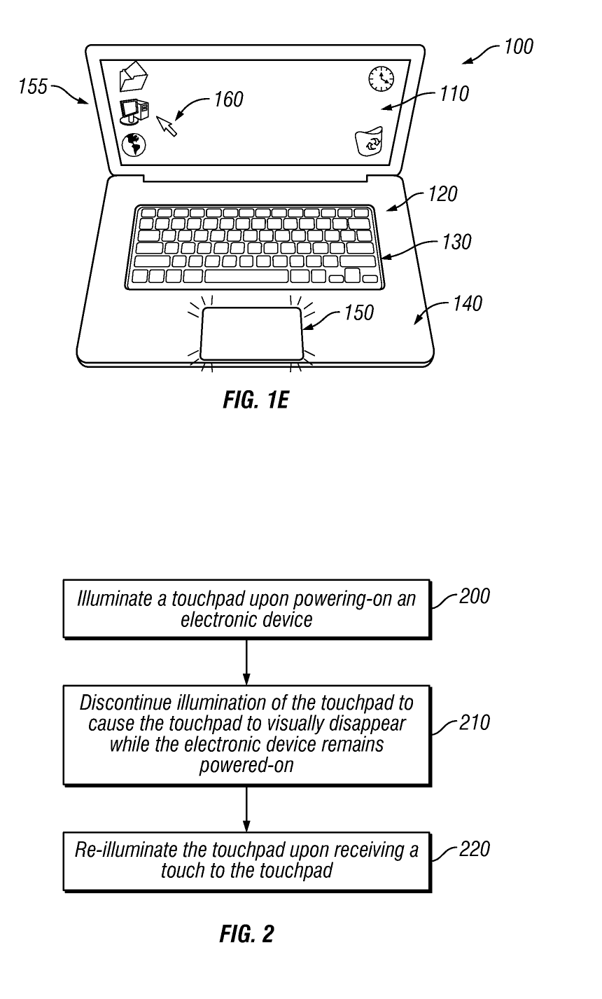

Example embodiments include apparatus and methods that use illumination without the use of textures or part lines to distinguish the area surrounding the touchpad of an electronic device with the area of the touchpad itself. FIGS. 1A-1E show examples of an electronic device with an illuminating touchpad.

FIG. 1A is an electronic device 100 in a power-off state in accordance with an example implementation. As used herein, electronic devices include, but are not limited to, notebook or laptop computers, tablet computers, personal digital assistants (PDAs), desktop computers, personal computers (PCs), mobile telephones, portable media players, gaming devices, and other portable and non-portable electronic and computing devices. By way of illustration, FIGS. 1A-1E show a notebook or laptop computer.

The electronic device 100 includes a display 110 that rotatably connects to a base 120. The base includes a keyboard 130 and a palmrest area 140 adjacent to and below the keyboard.

FIG. 1B is the electronic device 100 in a power-on state with a touchpad 150 illuminated in accordance with an example implementation. A light source 145 is located in the base 120 and underneath the touchpad 150. The light source 145 emits light through the surface of the touchpad so the touchpad is visible while the light source is powered-on. Light can illuminate an entire surface area of the touchpad 150 or portions of the touchpad. For example, the light can illuminate a border or boundary of the touchpad in order to indicate the location of the perimeter of the touchpad.

Since the touchpad is illuminated, it can be visually distinguished from the palmrest area 140 or other parts of the base 120 which are not illuminated. The palmrest area includes the surface area of the base adjacent to and surrounding the touchpad.

The display 110 includes various icons 155 to illustrate that the electronic device is powered-on and in an active state (as opposed to being powered-on and in an inactive state, such as a sleep mode or hibernation mode). In the active state, the electronic device can receive and respond to user interface (UI) events, such as typing events, mouse or touchpad clicks and movements, voice commands, etc.

As used herein, a touchpad (also called a trackpad) is a pointing device with a surface on an electronic device that controls movement of a cursor on a display. Movement of one or more of a user's fingers and thumb on the surface of the touchpad causes a cursor to move simultaneously on the display of the electronic device. For example, when a finger is dragged across a surface area of the touchpad 150, a cursor 160 on display 110 simultaneously moves.

Touchpads can also include various clicking, tapping, and dragging features. For example, pressing down or clicking the touchpad selects an object (such as an icon 155), and pressing down while selecting the object can move or drag it on the display. Touchpads can also include additional functionality, such as having edge regions that function as a scroll wheel and having hotspot zones that control applications, such as a tap zone that executes on a media application.

Touchpads provide tactile sensing using any one of various methods, such as capacitive sensing and inductive sensing. For example, capacitive sensing senses a capacitance when a user places a finger on the surface of the touchpad. Capacitance-based touchpads include two capacitive layers of a plurality of capacitors arranged in arrays and an insulating layer disposed between the two capacitive layers. A current is applied between opposing capacitors. When a finger is placed on the surface of the touchpad, a change in capacitance occurs at this location. Capacitance changes can be detected using other methods as well. For example, a transmitter creates an electric field that becomes disrupted to decrease capacitance at a location where a finger touches the surface of the touchpad.

FIG. 1C shows the electronic device 100 in a power-on and active state with the touchpad not being illuminated. The light source (shown in FIG. 1B at 145) is powered-off so the surface area and boundary of the touchpad are not illuminated. As shown in FIG. 1C, since the touchpad is no longer illuminated, it disappears from a surface of the base 120.

As shown in FIG. 1C, when the touchpad is not illuminated, the touchpad is not visually perceivable (i.e., the touchpad is invisible). The touchpad visually disappears from the base 120 when not illuminated while the electronic device remains powered-on and in the active state. The touchpad also visually disappears from the base 120 when the electronic device is powered-off (shown in FIG. 1A).

A variety of different methods and apparatus can be used to transition the touchpad 150 between an illuminated state (shown in FIG. 1B) and a non-illuminated state (shown in FIG. 1C). For example, after a predetermined time period of inactivity the touchpad automatically transitions from the illuminated state to the non-illuminated state. Alternatively, the touchpad can transition from the illuminated state to a dimmer state in which a lower intensity of brightness is provided through the touchpad. This predetermined time period can be established and programmed into the electronic device and/or set by a user. For instance, a user can use a menu option to set the predetermined time period to a given number of seconds and/or minutes. After this time period expires with no interim user activity to the touchpad, then the touchpad transitions from the illuminated state to the non-illuminated state. For instance, suppose that a user sets the time period to two minutes. If the user does not touch the touchpad for two minutes after it is illuminated, then the touchpad will transition from the illuminated state to the non-illuminated state. The electronic device can include a timer (such as a counter) to keep track of the amount of elapsed time that passes between touches to a surface of the touchpad.

FIG. 1D shows the electronic device 100 in the power-on state with the touchpad 150 being activated with a touch from a hand 190 of a user to re-illuminate the touchpad. The dashed-lines of touchpad 150 indicate the area where the touchpad is located; although the touchpad is invisible to a user while the touchpad is not illuminated.

FIG. 1E shows the electronic device 100 in the power-on and active states with the touchpad 150 illuminated after being activated in accordance with an example implementation.

After the touchpad transitions from an illuminated state (shown in FIG. 1B) to the non-illuminated state (shown in FIG. 1C), the user can re-activate or re-illuminate the touchpad with a variety of methods. For example, an object can be pressed against the touchpad to generate a click of the touchpad. Alternatively, the touchpad can be illuminated from the keyboard 130, from a button on the electronic device, from a menu option on the display, from activation of an icon on the display, or from a UI event.

As shown in FIG. 1C, the touchpad disappears when not illuminated because the touchpad seamlessly integrates with the palmrest area 140. As such, the touchpad does not include a visually perceivable or touchable perimeter or boundary since the touchpad lacks a part line between the touchpad itself and the area of the base surrounding the touchpad. In one example embodiment, the touchpad and the area surrounding the touchpad are continuously formed or integrated. For example, these two areas are integrally molded together during a molding process. Alternatively, the touchpad is mounted behind or underneath palmrest area.

The palmrest area and the touchpad can have equivalent textures. For instance, the touchpad and the base area surrounding the touchpad both have a smooth texture, both have a slightly roughened texture, etc. As such, the area surrounding the touchpad is indistinguishable (from touch and sight) from the area of the touchpad itself when the touchpad is not illuminated.

The touchpad and palmrest area can be molded from one or more polymers. Masking can then be utilized to make the palmrest area opaque and a surface of the touchpad translucent or semi-translucent. Thus, light will pass through the touchpad, but not pass through surrounding or adjacent areas.

FIG. 2 is a method for illuminating a touchpad on an electronic device in accordance with an example implementation.

According to block 200, a touchpad of an electronic device is illuminated upon powering-on of the electronic device. Before the electronic device is powered-on, the location of the touchpad is not visible. Once the touchpad is illuminated, its location on the electronic device is visible.

According to block 210, illumination of the touchpad discontinues and causes the touchpad to visually disappear (i.e., disappear from sight) while the electronic devices remains powered-on in the active state. When the touchpad is not illuminated, the surface area and boundary of the touchpad blend with the surface area of the palmrest area such that the touchpad disappears from view on the electronic device.

According to block 220, the touchpad re-illuminates upon receiving a touch to the touchpad. For example, when a user touches a surface of the electronic device where the touchpad is located, then a light source energizes and illuminates the touchpad.

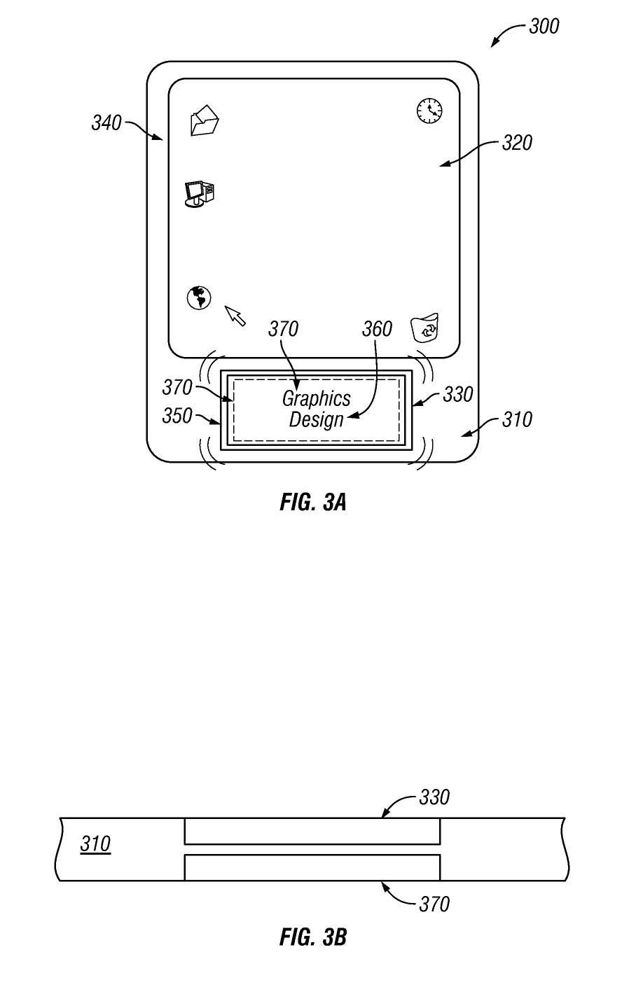

FIG. 3A is another example of an electronic device 300 in power-on and active states with a touchpad illuminated in accordance with an example implementation. The electronic device 300 includes a body or base 310 having a display 320 and a touchpad 330. The display 320 includes a plurality of icons 340 to illustrate that the electronic device is in the power-on and active states.

In order to visually indicate a location of the touchpad to a user, the surface area of the touchpad can be illuminated (such as shown in FIG. 1B). The entire or complete surface area of the touchpad, however, does not have to be illuminated. For example, FIG. 3A shows a rectangular shaped perimeter or boundary 350 that is illuminated to identify the location of the touchpad. This boundary 350 can be illuminated while a central portion 360 of the touchpad remains non-illuminated. Alternatively, the boundary 350 can be illuminated with one brightness or color, while the central portion 360 is illuminated with a different brightness or color. For example, the boundary 350 is illuminated with a higher intensity or brightness of light than the central portion 360. As another example, the boundary 350 is illuminated with a differently colored light than the central portion 360.

Additionally, the touchpad 330 can be provided with a graphics design 370 that can be illuminated to assist in identifying a location of the touchpad. For example, the graphics design can be a logo, picture, photograph, image, or other artwork selected by a user. This graphics design depicts a visual presentation on a surface of the touchpad when the light source is on. Thus, the graphics design can provide the user with a visual indication of the location of the touchpad.

A light source 370 (shown with dashed lines) is provided in the base 310 in order to provide light to illuminate the touchpad 330, including the boundary 350, the central portion 360, and the graphics design 370.

FIG. 3B is a cross-section of the base 310 showing the touchpad 330 and the light source 370. The light source is located in the base and under the touchpad to provide light through the touchpad. By way of example, the light source includes, but is not limited to, one or more of a light pipe and light emitting diodes (LEDs).

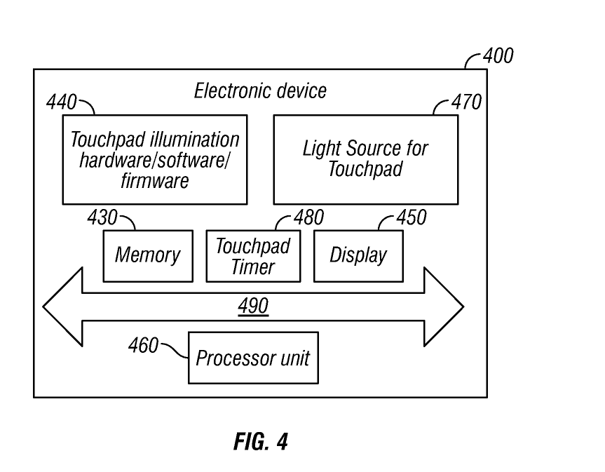

FIG. 4 is a block diagram of an electronic device 400 with a touchpad that illuminates in accordance with an example implementation. The electronic device includes memory 430, computer readable storage medium including touchpad illumination hardware, firmware, and/or software 440, a display 450, a processing unit 460, a light source to illuminate the touchpad 470, a touchpad timer 480, and buses or communication paths 490.

The processor unit 460 includes a processor (such as a central processing unit, CPU, microprocessor, application-specific integrated circuit (ASIC), etc.) for controlling the overall operation of memory 430 (such as random access memory (RAM) for temporary data storage, read only memory (ROM) for permanent data storage, and firmware). The processing unit 460 communicates with memory 430, computer readable storage medium 440, touch light source 470, and touchpad timer 480 to perform operations identified in FIGS. 1-3. The memory 430, for example, stores applications, data, and programs (including software to implement or assist in implementing example embodiments) and other data.

Blocks discussed herein can be automated and executed by a computer or electronic device. The term “automated” means controlled operation of an apparatus, system, and/or process using computers and/or mechanical/electrical devices without the necessity of human intervention, observation, effort, and/or decision.

The methods in accordance with example embodiments are provided as examples, and examples from one method should not be construed to limit examples from another method. Further, methods discussed within different figures can be added to or exchanged with methods in other figures. Further yet, specific numerical data values (such as specific quantities, numbers, categories, etc.) or other specific information should be interpreted as illustrative for discussing example embodiments. Such specific information is not provided to limit example embodiments.

In some example embodiments, the methods illustrated herein and data and instructions associated therewith are stored in respective storage devices, which are implemented as computer-readable and/or machine-readable storage media, physical or tangible media, and/or non-transitory storage media. These storage media include different forms of memory including semiconductor memory devices such as DRAM, or SRAM, Erasable and Programmable Read-Only Memories (EPROMs), Electrically Erasable and Programmable Read-Only Memories (EEPROMs) and flash memories; magnetic disks such as fixed, floppy and removable disks; other magnetic media including tape; optical media such as Compact Disks (CDs) or Digital Versatile Disks (DVDs). Note that the instructions of the software discussed above can be provided on computer-readable or machine-readable storage medium, or alternatively, can be provided on multiple computer-readable or machine-readable storage media distributed in a large system having possibly plural nodes. Such computer-readable or machine-readable medium or media is (are) considered to be part of an article (or article of manufacture). An article or article of manufacture can refer to any manufactured single component or multiple components.

What is claimed is:

1. An electronic device, comprising:
a display;
a base rotatably connected to the display;
a light source in the base; and
a touchpad located in the base to control movement of a cursor on the display, wherein the touchpad lacks a part line with an area of the base surrounding the touchpad and is illuminated by the light source.

2. The electronic device of claim 1, wherein the touchpad illuminates in response to touch, and visually disappears from the base when not illuminated while the notebook computer is powered-on and in an active state.

3. The electronic device of claim 1, wherein the touchpad includes a surface that is semi-translucent, and the light source is located beneath the touchpad to provide light through the surface of the touchpad.

4. The electronic device of claim 1, wherein after a predetermined time period the touchpad dims to a lower intensity of brightness while the notebook computer remains powered-on.

5. The electronic device of claim 1, wherein the area of the base surrounding the touch pad and a surface of the touchpad have a same surface texture.

6. An electronic device, comprising:
a body with a display;
a touchpad that includes a surface to control movement of a cursor on the display; and
a light source to illuminate the surface of the touchpad, wherein the touchpad has a perimeter that seamlessly integrates with a surface of the body surrounding the touchpad.

7. The electronic device of claim 6, wherein the touchpad is not visible in the body when the touchpad is not illuminated.

8. The electronic device of claim 6, wherein the touchpad includes a graphics design that depicts a visual presentation on the surface of the touchpad when the light source is on.

9. The electronic device of claim 6, wherein the light source illuminates a perimeter of the touchpad but not a central portion of the touchpad to identify the touchpad.

10. The electronic device of claim 6, wherein the light source increases a brightness of light through the surface of the touchpad when the touchpad is touched.

11. A non-transitory computer readable storage medium comprising instructions that when executed causes an electronic device to:
illuminate the touchpad upon powering-on of the electronic device;
discontinue illumination of the touchpad to cause the touchpad to visually disappear while the electronic device remains powered-on and in an active state; and
re-illuminate the touchpad upon receiving a touch to the touchpad.

12. The non-transitory computer readable storage medium of claim 11 including instructions to further cause the electronic device to: cause the touchpad to visually disappear after a predetermined period of time expires without receiving the touch.

13. The non-transitory computer readable storage medium of claim 11 including instructions to further cause the electronic device to: reduce illumination of the touchpad while the touchpad is in an inactive state while the electronic device remains powered-on.

14. The non-transitory computer readable storage medium of claim 11 including instructions to further cause the electronic device to: change a brightness of illumination of the touchpad to visually indicate that the touchpad is in an inactive state.

15. The non-transitory computer readable storage medium of claim 11 including instructions to further cause the electronic device to: illuminate a perimeter of the touchpad with a brightness or color that is different from a brightness or color at a center of the touchpad.
